(19) United States
(12) Patent Application Publication
(10) Pub. No.: US 2026/0145507 A1
(43) Pub. Date: May 28, 2026

(54) WHEEL ASSEMBLY STRUCTURE OF VEHICLE

(71) Applicants: HYUNDAI MOTOR COMPANY, SEOUL (KR); KIA CORPORATION, SEOUL (KR)

(72) Inventor: Jonghoon Lee, Hwaseong-si (KR)

(73) Assignees: HYUNDAI MOTOR COMPANY, SEOUL (KR); KIA CORPORATION, SEOUL (KR)

(21) Appl. No.: 19/292,627

(22) Filed: Aug. 6, 2025

(30) Foreign Application Priority Data
Nov. 25, 2024 (KR) 10-2024-0169660

(51) Int. Cl. B60K 7/00; B60G 3/01

(52) U.S. Cl. CPC B60K 7/0007; B60G 3/01; B60G 2204/182; B60G 2204/30; B60G 2300/50

(57) ABSTRACT

A wheel assembly structure of a vehicle is provided. The wheel assembly may include a wheel on which a tire of the vehicle is mounted, a rotor housing connected to the wheel and rotating with the wheel, a stator housing fixed to the vehicle, and configured to rotate the rotor housing by applying a current, and a wheel hub extending from a central portion of the wheel toward the vehicle inner side, a vehicle connection portion connected to the stator housing, and extending toward the vehicle inner side, and a shock absorber installed on the vehicle connection portion, and configured to alleviate the shock between the stator housing and the wheel.

### CROSS-REFERENCE TO RELATED APPLICATION(S)

This application claims priority to and the benefit of Korean Patent Application No. 10-2024-0169660 filed with the Korean Intellectual Property Office on Nov. 25, 2024, the entire contents of which is incorporated herein by reference.

### TECHNICAL FIELD

The present disclosure relates to a wheel assembly structure of a vehicle, and more particularly, the present disclosure relates to a wheel assembly structure provided with an in-wheel motor, and including a shock absorber for alleviating the load of the vehicle.

### BACKGROUND

An in-wheel drive system is mounted on each wheel of a vehicle. The system is mounted in vehicles that run on electric power such as hybrid vehicles, fuel cell vehicles, and electric vehicles, and generates and drives power for each vehicle wheel by installing a small individual motor on each vehicle wheel instead of using a large single motor.

The in-wheel drive system provides individual motors (hereinafter referred to as an in-wheel motor) for each wheel to simplify a drive system and increase an interior space compared to a vehicle equipped with a large drive motor. Also, the in-wheel drive system directly controls the rotation of the vehicle wheels to omit a complex power transmission device such as a differential device.

Power train elements may be omitted, exhibiting high efficiency and high performance. That is, by (e.g., directly) installing the in-wheel motor on the wheels of each vehicle wheel, it is possible to reduce power waste and secure sufficient driving power. By maximizing the distribution of power to each in-wheel motor during driving, the recovery of braking energy due to regenerative braking when braking improves fuel efficiency.

In the in-wheel drive system, the in-wheel motor is integrated with the wheels of the vehicle wheel, which may increase an unsprung mass of the vehicle, vibration and noise (NVH) of the vehicle, and there is a risk of damage to the in-wheel motor due to shock on a lower portion of the vehicle. In addition, configuring a wheel assembly structure to provide durability of the in-wheel motor and durability due to movement of a high-voltage cable when the wheels move may be challenging.

An in-wheel drive system is equipped with a shock absorber between the wheel and the stator housing to alleviate the shock between the stator housing and the wheel. A shock absorber support (e.g., knuckle), which holds the shock absorber, is connected to the wheel hub of the vehicle. If the shock absorber is not maintained with sufficient strength to withstand the front, rear, left, and right loads coming through the vehicle's tires, wheels, wheel hubs, and knuckles, damage to the load section may occur.

### SUMMARY

The present disclosure provides a wheel assembly structure of a vehicle capable of alleviating the shock transferred from a lower body of the vehicle to the in-wheel motor, and improves the strength and durability against lateral force by employing a shock absorber structure composed of a large pipe and a dual cylinder.

A wheel assembly structure of a vehicle is provided. The wheel assembly structure may include a wheel on which a tire of the vehicle is mounted, a rotor housing connected to the wheel and rotating with the wheel, a stator housing fixed to the vehicle, and configured to rotate the rotor housing by applying a current, and a wheel hub extending from a central portion of the wheel toward the vehicle inner side, a vehicle connection portion connected to the stator housing, and extending toward the vehicle inner side, and a shock absorber installed on the vehicle connection portion to alleviate the shock between the stator housing and the wheel.

A permanent magnet may be provided on an interior surface of the rotor housing facing a rotation axis of the rotor housing, and a coil may be provided on an exterior surface of the stator housing at a location facing the permanent magnet, so that the rotor housing may be operated to rotate by electromagnetic force generated by applying electric power to the coil.

A spring configured to support an upper surface of the vehicle connection portion, support the stator housing and a load of the vehicle, and alleviate a shock may be provided on a circumference of the shock absorber.

The shock absorber may be connected to the wheel hub by a wheel hub connecting member, and the wheel hub and the wheel hub connecting member may be rotatably connected by a wheel hub bearing.

The wheel hub connecting member may be fixedly coupled to an outer circumference of a central portion of a cylinder.

The vehicle connection portion may be connected to the stator housing in a shape surrounding the shock absorber.

The shock absorber may include a pipe having a first end fixed to an upper portion of the vehicle connection portion, and a second end extending toward a lower portion of the vehicle connection portion, a piston provided on an outer circumference of a second end portion of the pipe, a cylinder having a first end that is opened and a second end that is closed and sealed, and configured to reciprocally move in a vertical direction of the vehicle connection portion while an outer circumference of the piston is in contact with an inner surface, and a cylinder cap provided to close and seal a first end of the cylinder.

A second end of the pipe may penetrate a second end of the cylinder to be connected to the lower portion of the vehicle connection portion.

A bump stopper that is in contact with the vehicle connection portion and installed to surround the pipe, to be deformed to be compressed when contacted by the first end of the cylinder, is provided between a lower surface of the upper portion of the vehicle connection portion and a first end of the cylinder.

A first outer cylinder penetrated by the pipe and configured to surround an outer side of the first end of the cylinder may be provided between the bump stopper and a first end of the cylinder.

A first sliding member configured to enable the cylinder to slidably move on the inner side of the first outer cylinder may be provided between the outer side of the first end of the cylinder and an inner side of the first outer cylinder.

A second outer cylinder surrounding an outer side of a second end of the cylinder may be provided between the second end of the cylinder and a lower portion of the vehicle connection portion.

A second sliding member enabling the cylinder to slidably move on the inner side of the second outer cylinder may be provided between the outer side of the second end of the cylinder and an inner side of the second outer cylinder.

A wheel hub connecting member may be provided to be located between the first outer cylinder and the second outer cylinder.

According to an example embodiment, in a wheel assembly structure provided with an in-wheel motor including a stator and a rotor, by employing a shock absorber structure composed of a large pipe and a dual cylinder, the shock transferred from vehicle lower body to the in-wheel motor may be alleviated, so that the durability of a high voltage cable connected to the in-wheel motor may be strengthened.

In addition, by improving the strength of the shock absorber itself, the strength and the durability of the shock absorber against the lateral force applied to the vehicle may be improved.

In addition, by disposing the bump stopper on the outer side of the dual cylinder, the degree of design freedom of the bump stopper may be improved.

### BRIEF DESCRIPTION OF THE DRAWINGS

FIG. 1 is a cross-sectional view showing a wheel assembly structure of a vehicle according to an embodiment, when viewed from the front of the vehicle.

FIG. 2 is a cross-sectional view showing an example of a shock absorber of a wheel assembly structure of a vehicle according to an embodiment.

FIG. 3 is a cross-sectional view showing another example of a shock absorber of a wheel assembly structure of a vehicle according to an embodiment.

FIGS. 4A, 4B, and 4C are cross-sectional views showing an operation process of another example of a shock absorber of a wheel assembly structure of a vehicle according to an embodiment, shown in FIG. 3.

### DETAILED DESCRIPTION

The present disclosure will be described more fully hereinafter with reference to the accompanying drawings, in which embodiments of the disclosure are shown. The described embodiments may be modified in various different ways without departing from the spirit or scope of the present disclosure.

In various example embodiments, the same reference numerals are used for elements having the same configurations and may be representatively described in a first example embodiment, and in other example embodiments, such that elements different from those of the first example embodiment may be described.

The drawings are schematic, and are not illustrated in accordance with a scale. Relative dimensions and ratios of portions in the drawings are illustrated to be exaggerated or reduced in size for clarity, and the dimensions are examples and are not limiting. In addition, like structures, elements, or components illustrated in two or more drawings may use the same reference numerals for showing similar features. When an element such as a layer, film, region, or substrate is referred to as being “on” another element, it may be (e.g., directly) on the other element or intervening elements may also be present.

Various modifications of the drawings may be expected. Therefore, the embodiments herein are not limited to a shape of an illustrated component (e.g., region), but, for example, may include a change in the shape during manufacturing.

Hereinafter, a wheel assembly structure of a vehicle according to an example embodiment of the present disclosure is described in detail with reference to the accompanying drawings.

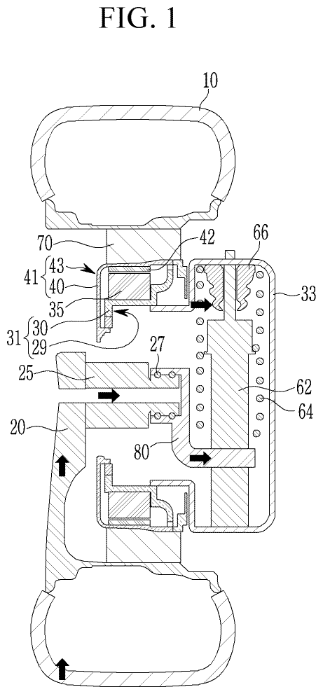

FIG. 1 is a cross-sectional view showing a wheel assembly structure of a vehicle according to an embodiment, when viewed from the front of the vehicle.

A wheel assembly structure of a vehicle according to an example embodiment may include a wheel 20 on which a tire 10 of the vehicle mounted, a rotor housing 40 connected to the wheel 20 and configured to rotate with the wheel 20, and a stator housing 30 fixed to the vehicle and configured to rotate the rotor housing 40 by applying a current.

The stator housing 30 and the rotor housing 40 may be provided inside a rotor 43 to form an in-wheel motor. In-wheel motors 31 and 41 may be an electric vehicle drive system that drives wheels by (e.g., directly) mounting an electric motor on each wheel. Unlike a drive method using an internal combustion engine and a transmission, efficient energy transfer is possible because the wheels and motors are directly connected.

The wheel 20 may be (e.g., mainly) made of metal and rotates about a central axis. The wheel 20 serves to support the tire 10, reduces shock received from the road, and supports a weight of the vehicle.

The tire 10 surrounds an exterior of the wheel 20 and is (e.g., mainly) made of rubber and steel wire. The tire 10 may control a direction and speed of the vehicle by using friction with a road surface. The tire 10 absorbs the shock from the road surface to provide a comfortable driving environment and increases vehicle safety.

The rotor 43 may be connected to an interior of the wheel 20 and may rotate with the wheel 20. The rotor 43 may be (e.g., a portion) configured to rotate upon receiving electricity in the in-wheel motors 31 and 41. The rotor 43 may serve to transfer the torque of the engine to the wheel. A rotation of the rotor 43 primarily converts power into mechanical energy.

A stator 29 may be fixed to the vehicle, and may rotate the rotor 43 by applying a current. The stator 29 is a fixed part of the in-wheel motors 31 and 41 and may be (e.g., mainly) made of coils 35 or magnets 42. When the electrical energy passes through the stator 29, a magnetic field may be generated, and this magnetic field can rotate the rotor 43.

A bearing may be provided between the rotor 43 and the stator 29. The bearing allows a shaft to move between the rotor 43 and the stator 29 and supports the smooth rotation of the internal parts.

A damping device 70 may be interposed between an upper surface of the rotor housing 40 and a lower surface of the wheel 20. The damping device 70 may be made of an elastic polymeric material. In addition, the damping device 70 may be an air spring. Due to the damping device 70, the wheel 20 and the in-wheel motors 31 and 41 may relatively move up and down, may protect the in-wheel motors 31 and 41 from the shock from below, and may reduce vibration.

In addition, the damping device 70 may be provided on an outer side of the in-wheel motors 31 and 41, that is, on an outer circumference of the stator housing 30. In addition, the damping device 70 may be provided on a circumference of a central shaft of the rotor housing 40.

Meanwhile, a wheel assembly structure of a vehicle according to an example embodiment may be applied to, for example, a purpose-built vehicle (PBV). The wheel assembly structure may be modularized and applied to an underbody (e.g., skateboard) of the vehicle body of the PBV.

Meanwhile, a wheel assembly structure of a vehicle according to an example embodiment may include a wheel hub 25 extending from a central portion of the wheel 20 toward vehicle inner side, a vehicle connection portion or vehicle connector 33 connected to the stator housing 30, extending toward the vehicle inner side, and a shock absorber 62 installed on the vehicle connection portion 33, configured to alleviate the shock between the stator housing 30 and the wheel 20.

The wheel hub 25 may protrude from the central portion of the wheel 20 toward the vehicle inner side, and a wheel hub connecting member or wheel hub connector 80 may be coupled (e.g., provided) to the protruded portion. A first end of the wheel hub connecting member 80 may (e.g., be connected to) surround a protruding portion of the wheel hub 25, and may (e.g., be connected to) (e.g., relatively) rotate via a wheel hub bearing 27. A second end of the wheel hub connecting member 80 may be connected to the shock absorber 62.

The vehicle connection portion 33 may be connected to an inner side of the stator housing 30, and may protrude toward the vehicle inner side. In addition, the shock absorber 62 may be installed in the vehicle connection portion 33. The vehicle connection portion 33 may be connected to the stator housing 30 (e.g., in a shape) surrounding the shock absorber 62.

The shock absorber 62 may be installed on an inner side of the vehicle connection portion 33, and may be connected to the wheel hub connecting member 80. A spring 64 configured to support an upper surface of the vehicle connection portion 33, support the load of the stator housing 30 and the vehicle, and alleviate shock may be provided on a circumference of the shock absorber 62.

The shock absorber 62 is an example of a suspension, and may be installed on the inner side of the vehicle connection portion 33 to absorb the shock from the road surface, thereby serving to improve ride comfort and reduce damage to the vehicle.

The shock absorber 62 may have an upper end supported by the upper side vehicle connection portion 33 by a bump stopper 66. A bump stopper 66 may prevent the shock absorber 62 from being in (e.g., direct) contact and colliding with the vehicle connection portion 33. The bumper stopper 66 may be made of a polymer material having elasticity.

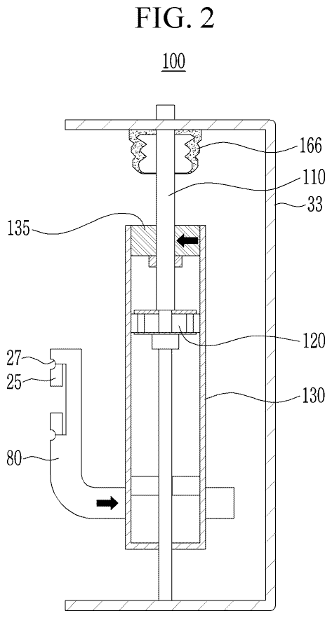

FIG. 2 is a cross-sectional view showing an example of the shock absorber of a wheel assembly structure of a vehicle according to an embodiment.

Referring to FIG. 2, a shock absorber 100 may be composed of a pipe 110, a piston 120, a cylinder 130, and a cylinder cap 135. In this embodiment, as shown, the spring installed on the circumference of the shock absorber 100 may be omitted.

The pipe 110 may have a first end fixed to an upper portion of the vehicle connection portion 33 and a second end extending toward a lower portion of the vehicle connection portion 33. A bump stopper 166 installed to surround the pipe 110 and deformed to be compressed, when contacted by a first end of the cylinder 130, may be provided on a lower surface of the upper portion of the vehicle connection portion 33 and an outer circumference of a first end of the pipe 110.

The piston 120 may be provided on an outer circumference of a second end portion of the pipe 110 and may be in (e.g., tight) contact with an inner wall of the cylinder 130.

The cylinder 130 may have a first end (e.g., opened) and a second end (e.g., closed and sealed). While an outer circumference of the piston 120 is in contact with the inner surface, the cylinder 130 may reciprocally move in a vertical direction of the vehicle connection portion 33. That is, while the pipe 110 and the piston 120 are fixed, the cylinder 130 may move while being in contact with the outer circumference of the piston 120 in the vertical direction of the vehicle connection portion 33.

A second end of the pipe 110 may extend into the cylinder 130 by penetrating the piston 120. In addition, the second end of the pipe 110 may penetrate a second end of the cylinder 130 to be connected to the lower portion of the vehicle connection portion 33. A second end portion of the cylinder 130, by which the second end of the pipe 110 is penetrated, may slidably move in a length direction of the pipe 110 while closing and sealing the interior of the cylinder 130.

The cylinder cap 135 may be provided to close and seal the opened portion of the first end of the cylinder 130. In a central portion of the cylinder cap 135, the pipe 110 may be penetrated, and the central portion of the cylinder cap 135, where the pipe 110 is penetrated, may slidably move in the length direction of the pipe 110.

The shock absorber 100 may be connected to the wheel hub 25 by the wheel hub connecting member 80. The wheel hub connecting member 80 may be (e.g., fixedly) coupled to an outer circumference of a lower portion of the shock absorber 100. The wheel hub 25 and the wheel hub connecting member 80 may be rotatably connected by the wheel hub bearing 27. Therefore, even if the wheel hub 25 is rotated, the wheel hub connecting member 80 and the shock absorber 100 may not rotate.

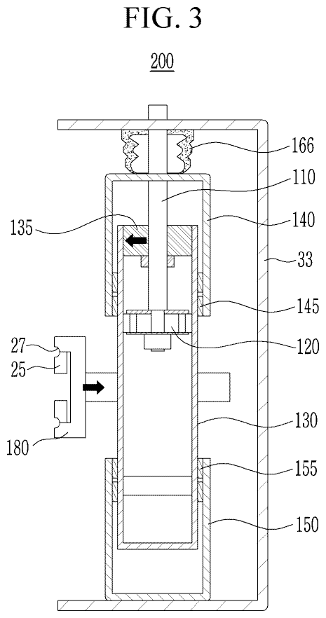

FIG. 3 is a cross-sectional view showing another example of the shock absorber of a wheel assembly structure of a vehicle according to an embodiment.

Referring to FIG. 3, a first outer cylinder 140 may be provided between a first end of the cylinder 130 and the bump stopper 166 of a shock absorber 200. The first outer cylinder 140 may surround an outer side of the first end of the cylinder 130, and the pipe 110 may penetrate a central portion of the upper surface.

In addition, a first sliding member 145 is configured to enable the cylinder 130 to be in (e.g., tight) contact with the inner side of the first outer cylinder 140 and slidably move. The first sliding member 145 may be provided between the outer side of the first end of the cylinder 130 and an inner side of the first outer cylinder 140. The first sliding member 145 may be provided on an outer circumference of the first end of the cylinder 130 or an inner circumference of the first outer cylinder 140, and the first sliding member 145 may be provided in a plural quantity.

A second outer cylinder 150 surrounding an outer side of the second end of the cylinder 130 may be provided between a second end of the cylinder 130 and a lower portion of the vehicle connection portion 33. The second outer cylinder 150 may be in contact with and supported by the lower portion of the vehicle connection portion 33.

In addition, a second sliding member 155 configured to enable the cylinder 130 to slidably move on the inner side of the second outer cylinder 150 may be provided between the outer side of the second end of the cylinder 130 and an inner side of the second outer cylinder 150. The second sliding member 155 may be provided on an outer circumference of the second end of the cylinder 130 or an inner circumference of the second outer cylinder 150, and the second sliding member 155 may be provided in a plural quantity.

Meanwhile, a wheel hub connecting member 180 may be (e.g., fixedly) coupled to an outer circumference of the cylinder 130 located between the first outer cylinder 140 and the second outer cylinder 150. The wheel hub 25 and the wheel hub connecting member 180 may be rotatably connected via the wheel hub bearing 27. Therefore, even if the wheel hub 25 is rotated, the wheel hub connecting member 180 and the cylinder 130 may not rotate.

The first end and the second end of the cylinder 130 may be located to have the outer sides of the first end of the cylinder 130 surrounded by the first outer cylinder 140 and the outer side of the second end of the cylinder 130 surrounded by the second outer cylinder 150, so that the up-and-down movement range of the cylinder 130, the wheel hub 25, and the wheel hub connecting member 180 may be limited by (e.g., the interval between) the first outer cylinder 140 and the second outer cylinder 150.

Meanwhile, the second outer cylinder 150 may be (e.g., in a state) fixed to a lower interior surface of the vehicle connection portion 33, and when the piston 120 moves upward and pushes an upper interior surface of the first outer cylinder 140 upward (e.g., through contact), the first outer cylinder 140 may (e.g., increase to) compress the bumper stopper 166.

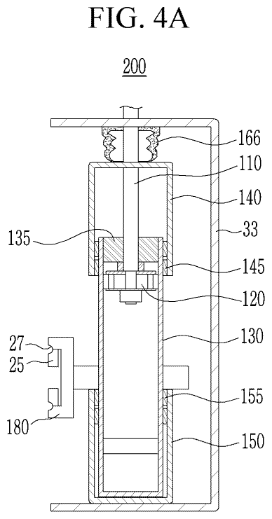

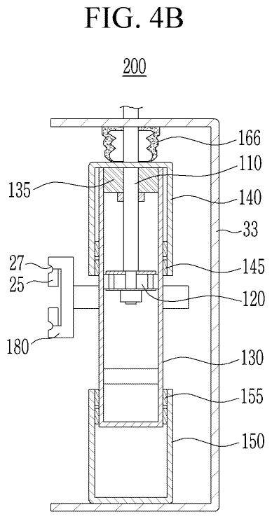

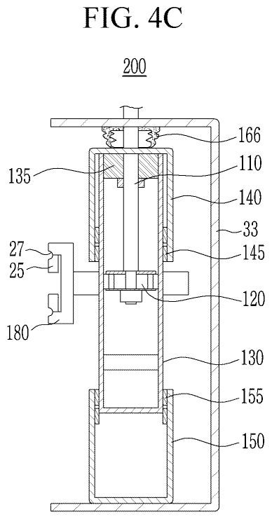

FIGS. 4A, 4B, and 4C are cross-sectional views showing an operation process of another example of a shock absorber of a wheel assembly structure of a vehicle according to an embodiment, shown in FIG. 3.

Referring to FIGS. 4A, 4B, and 4C, in a state that the bump stopper 166 of the shock absorber 200 is not compressed, a bottom portion of the second end of the cylinder 130 may be in contact with an interior bottom surface of the second outer cylinder 150. In addition, the wheel hub connecting member 180 is located close to the second outer cylinder 150, and the piston 120 is located close to the first end of the cylinder 130 (shown in FIG. 4A).

When a shock is applied to the vehicle from the road surface, while the pipe 110 and the piston 120 are fixed, the cylinder 130 and the first outer cylinder 140 moves upward by (e.g., the moment of) inertia. The bottom portion of the second end of the cylinder 130 may separate from the interior bottom surface of the second outer cylinder 150, and the first end of the cylinder 130 may contact the upper interior surface of the first outer cylinder 140. The second end of the cylinder 130 and the first end of the cylinder 130 may slidably move toward upper portions of the second outer cylinder 150 and the first outer cylinder 140, by the second sliding member 155 and the first sliding member 145, respectively. At this time, the bumper stopper 166 located between a lower surface of the vehicle connection portion 33 and an upper exterior surface of the first outer cylinder 140 starts being compressed (shown in FIG. 4B).

The cylinder 130 and the wheel hub connecting member 180 may have their upward movement ranges in the arrangement of the first outer cylinder 140. When the cylinder 130 (e.g., maximally) moves upward, the bump stopper 166 may be (e.g., fully or maximally) compressed. At this time, a length of the second outer cylinder 150 may be formed to have a length so that the second end of the cylinder 130 does not separate from the second outer cylinder 150 (shown in FIG. 4C).

When the shock is applied to the vehicle from the road surface, as shown in FIGS. 4A, 4B, and 4C, the cylinder 130 may reciprocally move between the first outer cylinder 140 and the second outer cylinder 150, and the cylinder 130 may move upward while being in contact with the upper interior surface of the first outer cylinder 140, so that the bump stopper 166 may be compressed and decompressed by the reciprocal movement. By such a process, the shock of the vehicle lower body may be alleviated, and by employing a dual cylinder structure of the cylinder 130, the first outer cylinder 140, and the second outer cylinder 150, a shock along a transverse direction of the vehicle may also be alleviated.

As such, according to an example embodiment, in a wheel assembly structure provided with the in-wheel motor including the stator and the rotor, by employing the shock absorber structure composed of a large pipe and a dual cylinder, the shock transferred from vehicle lower body to the in-wheel motor may be alleviated, strengthening the durability of a high voltage cable connected to the in-wheel motor.

In addition, by improving the strength of the shock absorber itself, the strength and the durability of the shock absorber against the lateral force applied to the vehicle may be improved.

In addition, by disposing the bump stopper on the outer side of the dual cylinder, a degree of design freedom of the bump stopper may be improved.

While this disclosure has been described with example embodiments, it is to be understood that the disclosure is not limited to the disclosed embodiments. Rather, the present disclosure is intended to cover various modifications and (e.g., substantially) equivalent arrangements.

What is claimed is:

1. A wheel assembly structure of a vehicle, comprising:
a wheel with a tire of the vehicle mounted on the wheel;
a rotor housing connected to the wheel, the rotor housing is configured to rotate with the wheel;
a stator housing coupled to the vehicle, the stator housing is configured to rotate the rotor housing by applying a current; and
a wheel hub extending from a central portion of the wheel toward an inner side of the vehicle;
a vehicle connector connected to the stator housing extends toward the inner side of the vehicle; and
a shock absorber installed on the vehicle connector is configured to alleviate a shock between the stator housing and the wheel.

2. The wheel assembly structure of claim 1, wherein
a permanent magnet is provided on an interior surface of the rotor housing facing a rotation axis of the rotor housing.

3. The wheel assembly structure of claim 2, wherein
a coil is provided on an exterior surface of the stator housing at a location facing the permanent magnet.

4. The wheel assembly structure of claim 3, wherein the rotor housing rotates by electromagnetic force generated by applying electric power to the coil.

5. The wheel assembly structure of claim 1, wherein a spring is configured to support an upper surface of the vehicle connector, support the stator housing and a load of the vehicle, and alleviate shock.

6. The wheel assembly structure of claim 5, wherein the spring is provided on a circumference of the shock absorber.

7. The wheel assembly structure of claim 1, wherein:
the shock absorber is connected to the wheel hub by a wheel hub connector.

8. The wheel assembly structure of claim 7, wherein
the wheel hub and the wheel hub connector are rotatably connected by a wheel hub bearing.

9. The wheel assembly structure of claim 7, wherein the wheel hub connector is coupled to an outer circumference of a central portion of a cylinder.

10. The wheel assembly structure of claim 1, wherein the vehicle connector is connected to the stator housing in a shape surrounding the shock absorber.

11. The wheel assembly structure of claim 10, wherein the shock absorber comprises:
a pipe having a first end coupled to an upper portion of the vehicle connector and a second end extending toward a lower portion of the vehicle connector;
a piston provided on an outer circumference of the second end of the pipe;
a cylinder having a first end that is open and a second end that is closed and sealed, wherein the cylinder is configured to reciprocally move in a vertical direction of the vehicle connector while an outer circumference of the piston is in contact with an inner surface of the cylinder; and
a cylinder cap provided to close and seal the first end of the cylinder.

12. The wheel assembly structure of claim 11, wherein the second end of the pipe penetrates the second end of the cylinder to be connected to the lower portion of the vehicle connector.

13. The wheel assembly structure of claim 11, wherein a bump stopper is in contact with the vehicle connector and is installed to surround the pipe.

14. The wheel assembly structure of claim 13, wherein the bump stopper is provided between a lower surface of the upper portion of the vehicle connector and the first end of the cylinder.

15. The wheel assembly structure of claim 14, wherein the bump stopper is configured to be compressed when contacted by the first end of the cylinder.

16. The wheel assembly structure of claim 13, wherein a first outer cylinder penetrated by the pipe and configured to surround an outer side of the first end of the cylinder is provided between the bump stopper and a first end of the cylinder.

17. The wheel assembly structure of claim 16, wherein a first sliding member configured to slidably move the cylinder on an inner side of the first outer cylinder is provided between the outer side of the first end of the cylinder and an inner side of the first outer cylinder.

18. The wheel assembly structure of claim 17, wherein a second outer cylinder surrounding an outer side of a second end of the cylinder is provided between the second end of the cylinder and the lower portion of the vehicle connector.

19. The wheel assembly structure of claim 18, wherein a second sliding member configured to slidably move the cylinder on an inner side of the second outer cylinder is provided between the outer side of the second end of the cylinder and an inner side of the second outer cylinder.

20. The wheel assembly structure of claim 18, wherein a wheel hub connector is provided between the first outer cylinder and the second outer cylinder.
